(19) United States
(12) Patent Application Publication
(10) Pub. No.: US 2012/0012754 A1
(43) Pub. Date: Jan. 19, 2012

(54) Diffraction grating, method for producing the same, and radiation imaging apparatus

(75) Inventor: Yasuhisa Kaneko, Kanagawa (JP)

(73) Assignee: FUJIFILM Corporation, Tokyo (JP)

(21) Appl. No.: 13/068,000

(22) Filed: Jul. 14, 2011

(30) Foreign Application Priority Data
Jul. 16, 2010 (JP) 2010-161548

(51) Int. Cl. G01T 1/00; B23P 11/00; G02B 5/18

(52) U.S. Cl. 250/393; 359/570; 29/428

(57) ABSTRACT

When a substrate is curved cylindrically, stress concentrates along a stress concentration line on the substrate. First to fourth sub-diffraction gratings are arranged on the substrate such that the stress concentration line overlaps one of the sub-diffraction gratings. This reinforces the substrate to improve its stiffness along the stress concentration line and thus prevents the damage to the substrate along the stress concentration line. Additionally, for example, the first to fourth sub-diffraction gratings are arranged on the substrate such that a gap between the first and second sub-diffraction gratings is out of alignment with a gap between the third and fourth sub-diffraction gratings in a direction of the stress concentration line. This also reinforces the substrate and prevents the damage to the substrate along a line or a portion other than the stress concentration line.

### BACKGROUND OF THE INVENTION

1. Field of the Invention

The present invention relates to a radiation imaging apparatus for phase imaging, a diffraction grating used in the radiation imaging apparatus, and a method for producing the diffraction grating.

2. Description Related to the Prior Art

An X-ray imaging system using Talbot effect is one of techniques for X-ray phase imaging. Using the X-ray phase imaging, an image (hereinafter referred to as the phase contrast image) is obtained based on a phase change (an angular change) of radiation, for example, an X-ray beam, caused by an object.

The X-ray imaging system has an X-ray source, a first diffraction grating, a second diffraction grating, and an X-ray image detector. The first diffraction grating is placed behind the object when viewed from the X-ray source. The second diffraction grating is placed downstream from the first diffraction grating by a Talbot length in an X-ray emission direction. The Talbot length is determined by a grating pitch of the first diffraction grating and an X-ray wavelength. The X-ray image detector is placed behind the second diffraction grating. The X-ray beams passed through the first diffraction grating form a self image (fringe image) at the second diffraction grating due to the Talbot effect. The self image is modulated by an interaction between the object and the X-ray beam, that is, the phase change of the X-ray beam caused by the object.

Superposing the self image onto the second diffraction grating modulates intensity of the fringe image. The intensity-modulated fringe image is detected using a fringe scanning method. Thereby, a phase contrast image of the object is obtained from a change (the phase change) in the fringe image caused by the object.

Each of the first and second diffraction gratings has a stripe structure composed of X-ray transmitting members and X-ray absorbing members (hereinafter referred to as the X-ray shielding members) arranged alternately. To detect the change in the fringe image caused by the object, each of the first and second diffraction gratings needs to have a fine stripe structure at a pitch of several μm in an arranging direction of the X-ray shielding members. Especially, in the second diffraction grating, each of the X-ray shielding members requires high X-ray absorption property, which is achieved with a high aspect ratio structure, for example, with the thickness (depth) of the order of 100 μm in a traveling direction of the X-ray beams. Accordingly, the second diffraction grating is produced by silicon semiconductor processes capable of fine processing (for example, see Japanese Patent Laid-Open Publication No. 2006-259264 and Japanese Patent Laid-Open Publication No. 2009-042528).

To increase a field of view of the X-ray imaging system, an area or the size of the second diffraction grating needs to be increased. However, there is an upper limit to the size of a wafer allowed to be processed in the silicon semiconductor processes. The size of a diffraction grating cannot exceed the size of the wafer.

When the size of the second diffraction grating is increased, it is necessary to avoid vignetting of the X-ray beams around its periphery and control convergence in its thickness direction. The X-ray source is a spot irradiation source that emits cone-shaped X-ray beams. The spot size of the cone-shaped X-ray beams increases with a distance from the X-ray source. Because all points on a wavefront of the X-ray beams are at equal distances from the X-ray source, the wavefront of the X-ray beams is curved. Thereby, an X-ray incident angle at a center portion of the second diffraction grating and an X-ray incident angle at a peripheral portion thereof are different from each other (nonparallel to each other). This causes vignetting, namely, the peripheral portion of the second diffraction grating does not allow the X-ray beams to pass through. Thus, an effective area of the second diffraction grating is reduced.

As shown in FIG. 11, small diffraction gratings (hereinafter referred to as the sub-diffraction gratings) 61 are arranged in rows on a substrate 62 to maximize the size of a second diffraction grating 60. Each of the sub-diffraction gratings 61 is composed of X-ray shielding members and X-ray transmitting members arranged alternately. To avoid the vignetting of the X-ray beams around the periphery of the large second diffraction grating 60, the substrate 62 is curved cylindrically before or after the sub-diffraction gratings 61 are joined to the substrate 62. However, the stress caused by the cylindrical curving concentrates along a line (hereinafter referred to as the stress concentration line) F. The stress concentration line F is located in the middle of the substrate 62 in a curving direction and extends orthogonally to the curving direction. As shown in FIG. 12, when the stress concentration line F is located in or coincides with gaps between the sub-diffraction gratings 61, the substrate 62 cracks or becomes broken and deformed along the stress concentration line F, resulting in peeling and failure of the second diffraction grating 60. Consequently, the second diffraction grating 60 impairs its function.

### SUMMARY OF THE INVENTION

An object of the present invention is to provide a diffraction grating, a method for producing the same, and a radiation imaging apparatus for preventing damage to a substrate along a stress concentration line when the diffraction grating is curved.

In order to achieve the above and other objects, a diffraction grating includes a curved substrate and two or more sub-diffraction gratings. The curved substrate has at least one stress concentration line where stress caused by a curve of the substrate concentrates. Each of the sub-diffraction gratings has a grating structure. The grating structure is composed of radiation shielding members and radiation transmitting members arranged alternately. The sub-diffraction gratings are joined to the substrate such that the stress concentration line overlaps at least one of the sub-diffraction gratings. It is preferable that the sub-diffraction gratings adjoin each other on the substrate such that gaps between the sub-diffraction gratings are out of alignment with each other in a direction of the stress concentration line. It is preferable that the gaps are located on opposite sides of and equidistant from the stress concentration line.

It is preferable that the sub-diffraction gratings adjoin each other on the substrate and a gap between the sub-diffraction gratings intersects the stress concentration line. In this case, it is preferable that a grating direction of the members and an edge of each sub-diffraction grating is nonparallel to each other.

It is preferable that the curve of the substrate is cylindrical. In this case, the stress concentration line is located in the middle of the substrate in a curving direction of the substrate and extends orthogonally to the curving direction. The curve of the substrate may be spherical. In this case, the substrate may be circular in shape and the stress concentration lines radially extend from the center of the substrate.

It is preferable that the substrate has radiation transmission property and a thermal expansion coefficient according to that of the sub-diffraction grating.

A radiation imaging apparatus includes a radiation source for emitting radiation, a first diffraction grating, a second diffraction grating, a third diffraction grating, and a radiation image detector. The first diffraction grating passes the radiation to form a fringe image. The second diffraction grating provides intensity modulation to the fringe image. The second diffraction grating is moved to relative positions that are out of phase with a periodic pattern of the fringe image. The third diffraction grating is disposed between the radiation source and the first diffraction grating. The third diffraction grating shields the radiation, emitted from the radiation source, in an area-selective manner to form a plurality of line irradiation sources. The radiation image detector detects an intensity-modulated fringe image. At least one of the first to third diffraction gratings is a diffraction grating composed of a curved substrate and two or more sub-diffraction gratings. Each of the sub-diffraction gratings has a grating structure. The grating structure is composed of radiation shielding members and radiation transmitting members arranged alternately. The substrate has at least one stress concentration line where stress concentrates when the substrate is curved. The sub-diffraction gratings are joined to the substrate such that the stress concentration line overlaps at least one of the sub-diffraction gratings.

A method for producing a diffraction grating of the present invention has a joining step and a curving step. In the joining step, two or more sub-diffraction gratings are joined to a substrate. Each of the sub-diffraction gratings has a grating structure. The grating structure is composed of radiation shielding members and radiation transmitting members arranged alternately. The substrate has at least one stress concentration line where stress concentrates when the substrate is curved. The sub-diffraction gratings are arranged on the substrate such that the stress concentration line overlaps at least one of the sub-diffraction gratings. In the curving step, the substrate is curved before or after the joining step.

According to the diffraction grating and the method for producing the same of the present invention, the sub-diffraction gratings are arranged on the substrate such that the stress concentration line overlaps at least one of the sub-diffraction gratings. This prevents the diffraction grating from damage including breakage of the substrate along the stress concentration line when the substrate is curved and peeling and cracks of the sub-diffraction grating due to the breakage. Thus, the diffraction grating maintains its function even if it is curved.

The sub-diffraction gratings are arranged such that gaps between the sub-diffraction gratings are out of alignment with each other in the direction of the stress concentration line. This prevents the damage to the substrate along a line or a portion other than the stress concentration line. In this case, at least two gaps that are out of alignment with each other are located on opposite sides, respectively, and equidistant from the stress concentration line. Thereby, the stiffness becomes uniform across the substrate with respect to the stress concentration line, making the curve of the substrate stable.

It is also preferable to prevent damage to the substrate along the stress concentration line by arranging the sub-diffraction gratings such that gaps between the adjoining diffraction gratings intersect the stress concentration line. In this case, by making the grating direction of the sub-diffraction grating and an edge of the sub-diffraction grating nonparallel to each other, the sub-diffraction gratings are arranged in appropriate directions without being restricted by the edges or gaps of the sub-diffraction gratings.

The diffraction grating of the present invention may be curved cylindrically or spherically. The substrate is made from a material having radiation transmission property. Thereby, reduction in performance of the diffraction grating is small despite the use of the substrate. The substrate is made from a material that has a thermal expansion coefficient similar to that of the sub-diffraction grating. Thereby, peeling of the sub-diffraction grating from the substrate due to a difference in thermal expansion coefficient is prevented.

According to the radiation imaging apparatus of the present invention, the size of the diffraction grating is increased, and thus, a wide field of view is obtained. The curved diffraction grating offers images with high image quality and reduced vignetting. Arranging the sub-diffraction gratings on the substrate such that the stress concentration line overlaps at least one of the sub-diffraction gratings prevents the damage to the diffraction grating due to the breakage of the substrate along the stress concentration line. Thus, maintenance burden is reduced, which contributes to overall cost reduction.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic diagram of an X-ray imaging apparatus using Talbot effect;

FIG. 2 is a front view of a second diffraction grating of a first embodiment;

FIG. 3 is a side view of the second diffraction grating of the first embodiment;

FIGS. 4A to 4D are explanatory views showing steps for producing a sub-diffraction grating;

FIGS. 5A and 5B are explanatory views showing steps for producing the second diffraction grating of the first embodiment;

FIG. 6 is a front view of a second diffraction grating of a second embodiment;

FIG. 7 is a front view of a second diffraction grating of a third embodiment;

FIG. 8 is a front view of a second diffraction grating of a fourth embodiment;

FIG. 9 is another configuration of the second diffraction grating of the fourth embodiment;

FIG. 10 is a front view of a second diffraction grating of a fifth embodiment;

FIG. 11 is a perspective view of a conventional second diffraction grating; and

FIG. 12 is a side view of the conventional second diffraction grating with a broken substrate.

### DESCRIPTION OF THE PREFERRED EMBODIMENTS

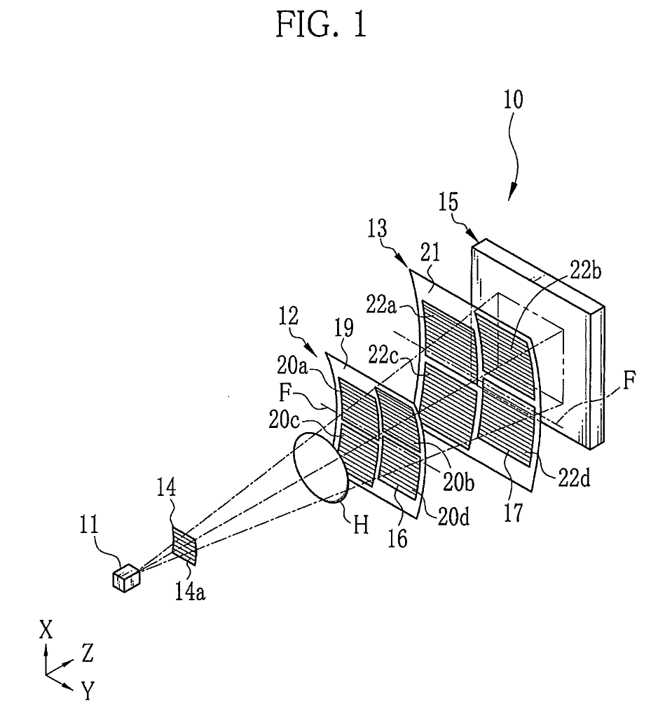

Referring to FIG. 1, a radiation imaging apparatus using a diffraction grating of the present invention, for example, an X-ray imaging apparatus 10 is described. The X-ray imaging apparatus 10 is composed of an X-ray source 11, a first diffraction grating 12, a second diffraction grating 13, a third diffraction grating 14, and an X-ray image detector 15. The X-ray source 11 emits X-ray beams to an object H arranged in a Z direction. The first diffraction grating 12 is a phase diffraction grating facing the X-ray source 11 in the Z direction. The second diffraction grating 13 is an amplitude diffraction grating arranged a Talbot length away from and parallel to the first diffraction grating 12 in the Z direction. The third diffraction grating 14 is an absorption grating located immediately downstream from the X-ray source 11. The X-ray image detector 15 faces the second diffraction grating 13. The X-ray image detector 15 is, for example, a flat panel detector (FPD) using a semiconductor circuit. Generally, the FPD is housed in a cassette to constitute a portable electronic cassette.

The first diffraction grating 12 is substantially rectangular in shape and is provided with a plurality of X-ray shielding members 16a. The X-ray shielding members 16a extend linearly in a Y direction orthogonal to the Z direction. The X-ray shielding members 16a are arranged periodically at a predetermined pitch along an X direction orthogonal to the Z and Y directions. Similar to the first diffraction grating 12, the second and third diffraction gratings 13 and 14 are rectangular in shape. The second diffraction grating 13 is provided with a plurality of X-ray shielding members 17a extending and arranged in the same directions as those of the X-ray shielding members 16a. The third diffraction grating 14 is provided with a plurality of X-ray shielding members 14a extending and arranged in the same directions as those of the X-ray shielding members 16a. Further, the first diffraction grating 12 is provided with a plurality of X-ray transmitting members 16b, and the X-ray shielding members 16a and the X-ray transmitting members 16b are arranged alternately. The second diffraction grating 13 is provided with a plurality of X-ray transmitting members 17b, and the X-ray shielding members 17a and the X-ray transmitting members 17b are arranged alternately. The third diffraction grating 14 is provided with a plurality of X-ray transmitting members 14b, and the X-ray shielding members 14a and the X-ray transmitting members 14b are arranged alternately. Gold, platinum, or lead with excellent X-ray absorption property is used for producing the X-ray shielding members 16a, 17a, and 14a. The first to third diffraction gratings 12 to 14 are convergently curved to allow the cone-shaped X-ray beams to pass through their respective peripheral portions so as to prevent vignetting.

In the X-ray imaging apparatus 10, the X-ray beams emitted from the X-ray source 11 is partly shielded or shielded in an area-selective manner by the X-ray shielding members 14a of the third diffraction grating 14. Thereby, an effective focal size in the X direction is reduced and thus a plurality of line irradiation sources (scattered sources) are formed in the X direction. A phase of the X-ray beam, emitted from the X-ray source 11, is changed as the X-ray beam passes through the object H. Then the X-ray beams pass through the first diffraction grating 12 and form a fringe image at the second diffraction grating 13. The fringe image carries transmission phase information of the object H determined by a refractive index of the object H and a transmission optical path length of the X-ray. Intensity of the fringe image is modulated by the second diffraction grating 13, and detected using a fringe scanning method, for example.

In the fringe scanning method, X-ray images of the object H are taken during the X-ray emissions at predetermined intervals. In each pause between the X-ray emissions, the second diffraction grating 13 is translationally moved relative to the first diffraction grating 12 at a scanning pitch, that is, one of equally-divided parts of a grating pitch, in a direction along a grating surface about an X-ray focal point. Namely, the second diffraction grating 13 is moved to relative positions that are out of phase with a periodic pattern of the fringe image formed by the first diffraction grating 12. When the second diffraction grating 13 is located in each of the relative positions, the X-ray source 11 emits the X-ray beams to the object H, and the X-ray image detector 15 takes an image. Then, a phase differential image (corresponding to angular distribution of the X-ray beams refracted by the object H) is obtained from a phase shift value (a difference in phase between the presence and the absence of the object H) of pixel data from each pixel in the X-ray image detector 15. The phase differential image is integrated in the fringe-scanning direction. Thereby, a phase contrast image of the object H is obtained.

### First Embodiment

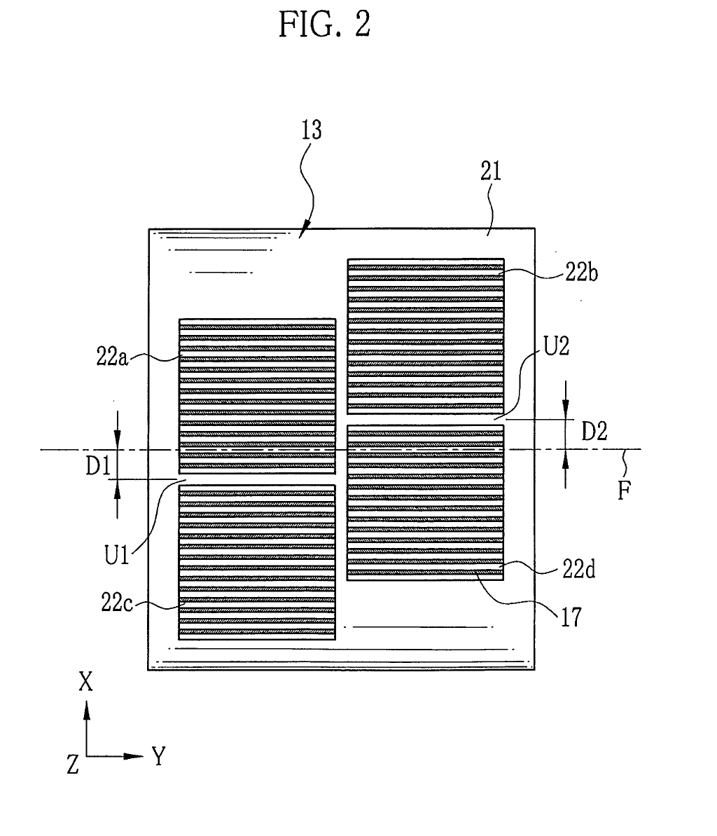

Next, a diffraction grating and a method for producing the same according to a first embodiment of the present invention are described. The first diffraction grating 12 is substantially rectangular in shape, and composed of a substrate 19 and four sub-diffraction gratings 20a to 20d arranged on the substrate 19. Each of the sub-diffraction gratings 20a to 20d is provided with the X-ray shielding members 16a. Similar to or the same as the first diffraction grating 12, the second diffraction grating 13 is composed of a substrate 21 and four sub-diffraction gratings 22a to 22d arranged on the substrate 21. Each of the sub-diffraction gratings 22a to 22d is provided with the X-ray shielding members 17a. Here, the second diffraction grating 13 is described by way of example. As shown in FIG. 2, to increase the size of the second diffraction grating 13, the sub-diffraction gratings 22a to 22d, each of which is a 10 cm square, are arranged on the substrate 21 with approximately 100 μm spacing.

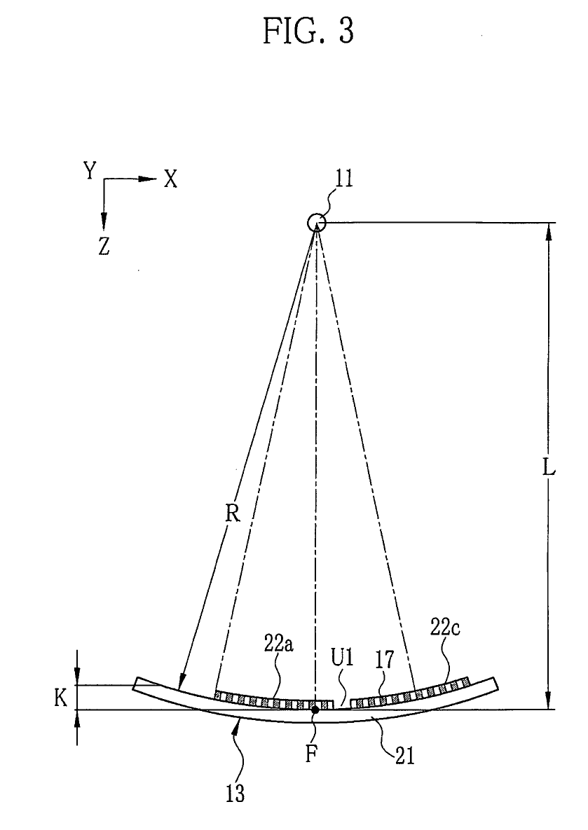

The first to third diffraction gratings 12 to 14 are convergently curved to allow the cone-shaped X-ray beams to pass through their respective peripheral portions so as to prevent vignetting. Each of the curves of the first to third diffraction gratings 12 to 14 is cylindrical (arc-shaped) about a center axis (not shown) that is a line extending in the Y direction orthogonal to the Z direction and passes through the focal point of the X-ray source 11. Here, the second diffraction grating 13 is described by way of example. As shown in FIG. 3, when a distance L between the focal point of the X-ray source 11 and the second diffraction grating 13 is 200 cm, for example, the second diffraction grating 13 is curved to have a radius R=200 cm. To pass the cone-shaped X-ray beams through the peripheral portion of the second diffraction grating 13, an amount of the curve K required is approximately 3 mm. Here, the amount of the curve (slope value) K is a distance between a center and an edge of the second diffraction grating 13 in the Z direction.

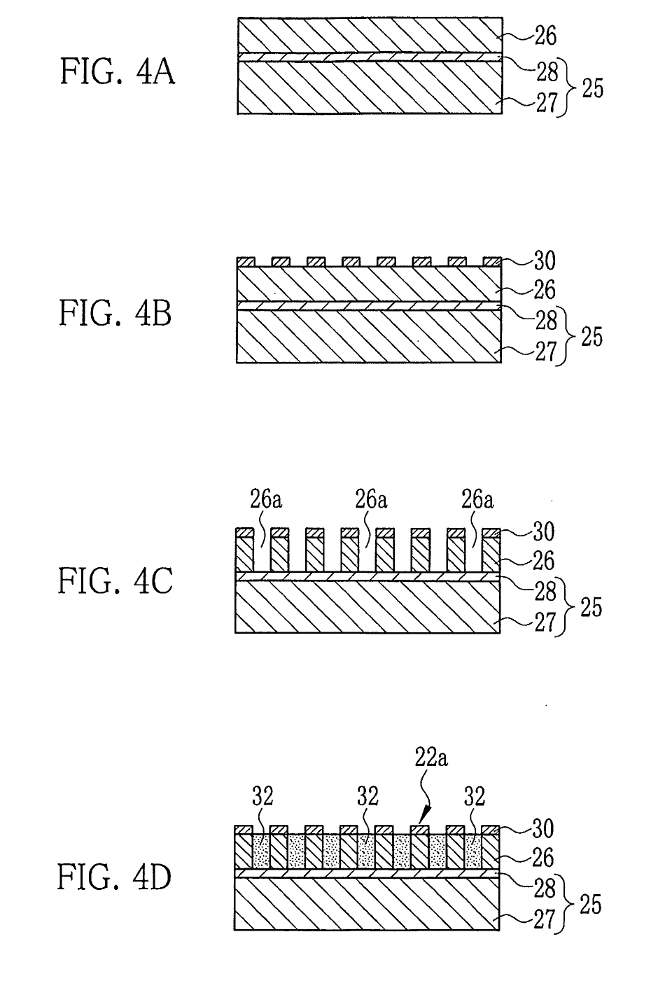

The sub-diffraction gratings 20a to 20d of the first diffraction grating 12, the sub-diffraction gratings 22a to 22d of the second diffraction grating 13, and the third diffraction grating 14 are formed or produced using silicon semiconductor processes. A method for producing the sub-diffraction grating 22a is briefly described by way of example. As shown in FIG. 4A, in a first step, a conductive substrate 25, being a base of the sub-diffraction grating 22a, and an etching substrate 26 are joined to each other. The conductive substrate 25 is composed of a support layer 27 and a conductive thin layer 28 provided to the support layer 27. An organic material with flexibility and low X-ray absorption property is used for producing the support layer 27. A metal film of Au, Ni, or the like is used for producing the conductive thin layer 28. A silicon wafer is used for producing the etching substrate 26.

Next, as shown in FIG. 4B, an etch mask 30 is formed on an upper face of the etching substrate 26 using a common photolithography technique. The etch mask has a stripe pattern extended linearly in a direction vertical to a paper plane and arranged periodically at a predetermined pitch in a lateral direction. As shown in FIG. 4C, a plurality of grooves 26a are formed on the etching substrate 26 by a dry etching process using the etch mask 30. The grooves 26a require a high aspect ratio, for example, of a depth of the order of 100 μm to a width of the order of several μm. Bosch process, cryo process, or the like is used as the dry etching process for forming the grooves 26a.

As shown in FIG. 4D, the grooves 26a are filled with gold (Au) 32 by an electroplating method using the conductive thin layer 28 as a seed layer. Thus, the X-ray shielding members 17a are formed. Thereafter, the etching substrate 26 and the conductive substrate 25, joined together, are cut to the size specified. Thus, the sub-diffraction grating 22a is produced. After the electroplating, one of the etching substrate 26 and the conductive substrate 25 may be removed.

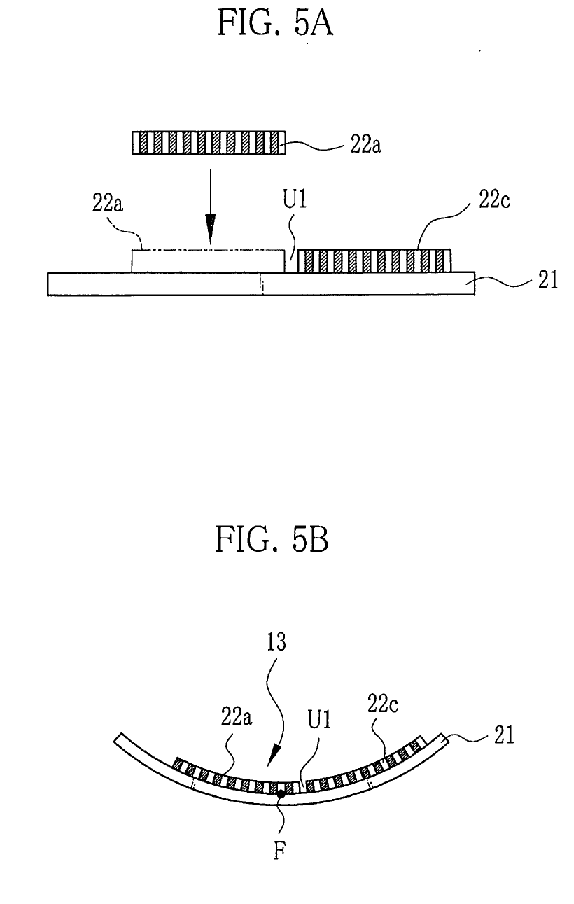

To produce the second diffraction grating 13, the sub-diffraction gratings 22a to 22d are joined to the flat substrate 21 as shown in FIG. 5A, and then the substrate 21 is cylindrically curved as shown in FIG. 5B. The substrate 21 is made from a material with low X-ray absorption property and a thermal expansion coefficient similar to that of the sub-diffraction gratings 22a to 22d. Each of the sub-diffraction gratings 22a to 22d is composed of silicon and Au. A thermal expansion coefficient of the silicon is 4.3×10⁻⁶/° C. A thermal expansion coefficient of the Au is 14.3×10⁻⁶/° C. Accordingly, glass (8.3×10⁻⁶/° C.), a carbon plate (5×10⁻⁶/° C.), aluminum (23×10⁻⁶/° C.), iron (12×10⁻⁶/° C.), or the like may be used as the substrate 21. Alternatively, the sub-diffraction gratings 22a to 22d may be joined to the already curved substrate 21.

As shown in FIG. 1, when the first and second diffraction gratings 12 and 13 are curved cylindrically, a stress concentration line F extends orthogonally to the curving direction substantially in the middle of each of the first and second diffraction gratings 12 and 13 in the curving direction. Like a substrate 62 shown in FIG. 12, the substrates 19 and 21 may crack or become broken along their respective stress concentration lines F, resulting in peeling and failure of the substrates 19 and 21. Thus, the first and second diffraction gratings 12 and 13 impair their respective functions. In the present invention, as shown in FIGS. 2 and 3, the sub-diffraction gratings 22a to 22d are arranged on the substrate 21 such that the stress concentration line F overlaps at least one of the sub-diffraction gratings 22a to 22d. This reinforces the substrate 21 to improve its stiffness along the stress concentration line F, preventing the breakage of or damage to the substrate 21.

To prevent the damage to the substrate 21 along a line or a portion other than the stress concentration line F, it is preferable to arrange the sub-diffraction gratings 22a to 22d on the substrate 21 such that gaps between the sub-diffraction gratings are out of alignment with each other in the direction of the stress concentration line F, for example, the gap 01 between the sub-diffraction gratings 22a and 22c is out of alignment with the gap U2 between the sub-diffraction grating 22b and 22d in the direction of the stress concentration line F. In this case, the gap U1 and the gap U2 are located on the opposite sides of and equidistant from the stress concentration line F. Namely, a distance D1 between the gap U1 and the stress concentration line F is equal to a distance D2 between the gap U2 and the stress concentration line F. Thereby, the stiffness of the substrate 21 becomes uniform in the curving direction, making the curve of the diffraction grating stable. Thus, the size of each of the first and second diffraction gratings 12 and 13 is increased, and as a result, a wide field of view is obtained. Because the first and second diffraction gratings 12 and 13 are curved, an image with high quality and reduced vignetting is obtained. Furthermore, the damage to the first and second diffraction gratings 12 and 13 along their respective stress concentration lines F is reduced. As a result, maintenance burden is reduced, which contributes to overall cost reduction.

### Second Embodiment

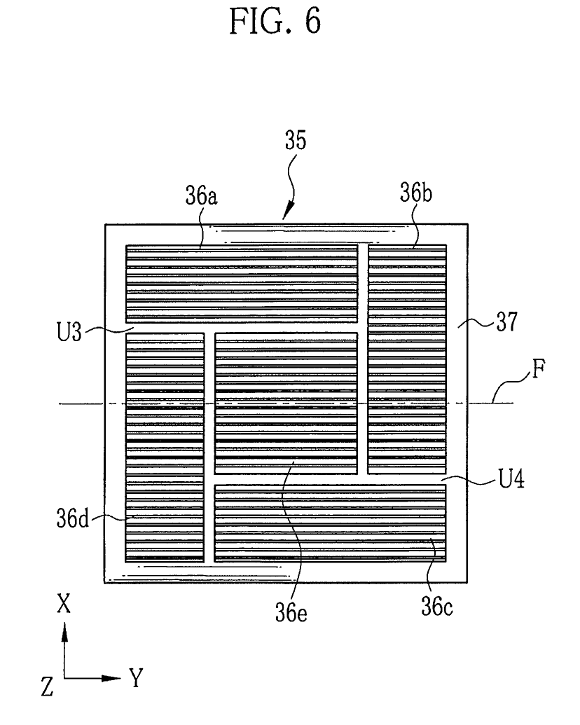

Like a diffraction grating 35 shown in FIG. 6, when sub-diffraction gratings 36a to 36e are arranged on a substrate 37 in rows along a stress concentration line F, it is preferable to arrange the sub-diffraction gratings 36b and 36c such that a gap U4 is out of alignment with a gap U3 in the direction of the stress concentration line F. This prevents the damage to the substrate 37 along the stress concentration line F and also along a line or a portion other than the stress concentration line F.

### Third Embodiment

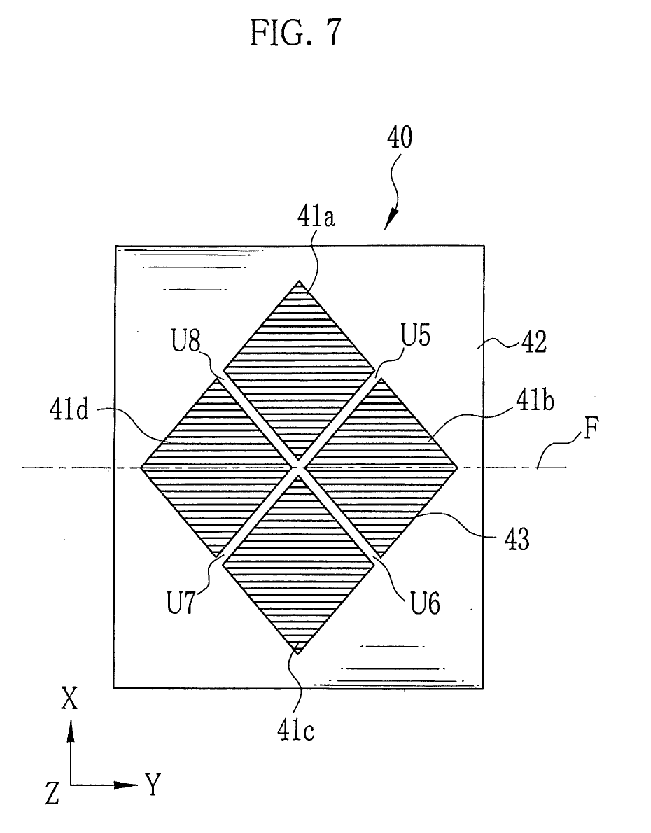

Like a diffraction grating 40 shown in FIG. 7, sub-diffraction gratings 41a to 41d may be arranged on a substrate 42 such that gaps U5 to U8 intersect a stress concentration line F. The gap U5 is between the sub-diffraction gratings 41a and 41b. The gap U6 is between the sub-diffraction gratings 41b and 41c. The gap U7 is between the sub-diffraction gratings 41c and 41d. The gap U8 is between the sub-diffraction gratings 41d and 41a. Like the sub-diffraction gratings 41a to 41d, when a grating direction (an extending direction of X-ray shielding members 43) and an edge of each of the sub-diffraction gratings 41a to 41d are nonparallel to each other, the gaps U5 to U8 intersect the stress concentration line F.

### Fourth Embodiment

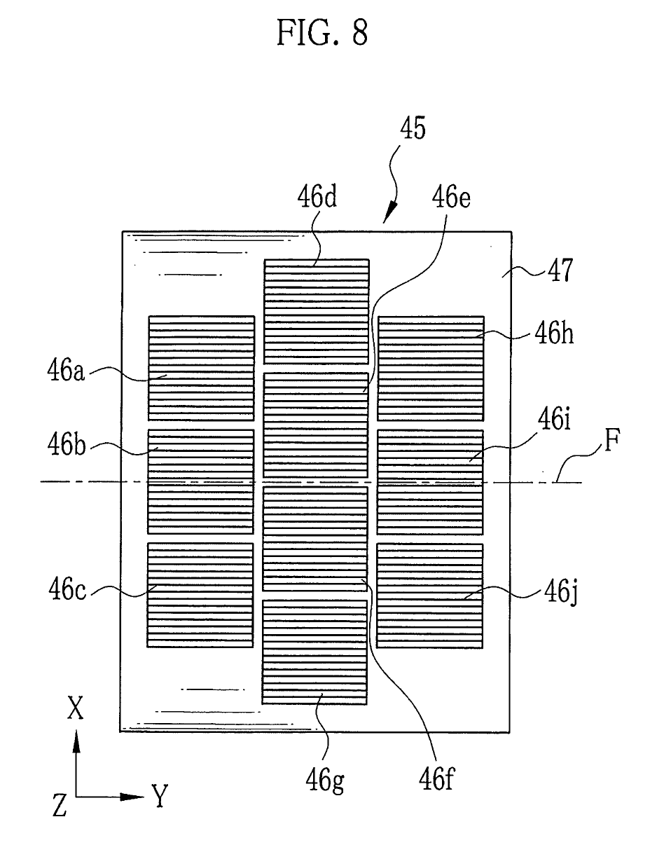

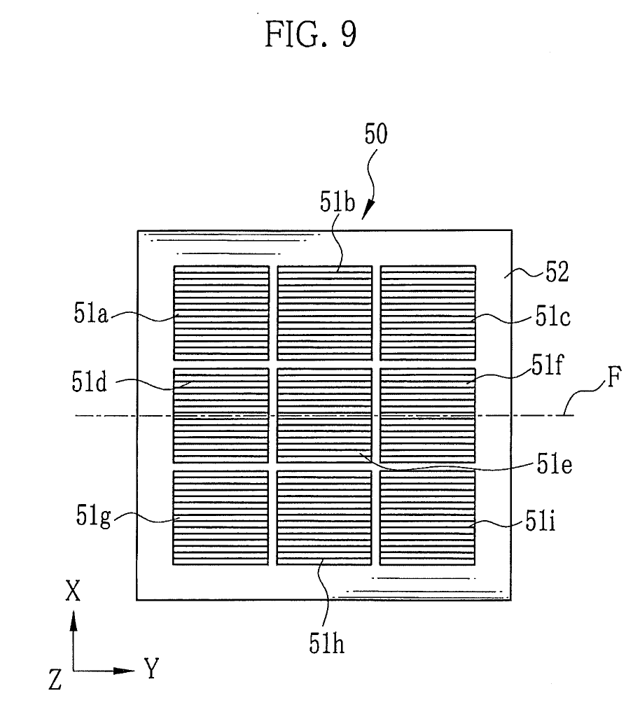

Like a diffraction grating 45 shown in FIG. 8, sub-diffraction gratings 46a to 46j may be in a staggered arrangement, in a direction of a stress concentration line F, on a substrate 47. Like a diffraction grating 50 shown in FIG. 9, sub-diffraction gratings 51a to 51i may be arranged linearly on a substrate 52, in the direction of and orthogonal to a stress concentration line F, though this arrangement is not consistent with the above condition that the gaps between the sub-diffraction gratings are out of alignment with each other in the direction of the stress concentration line F.

### Fifth Embodiment

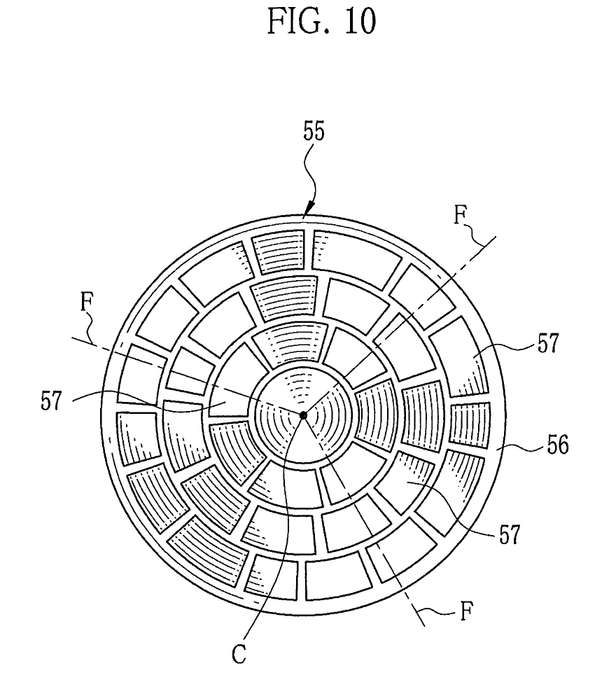

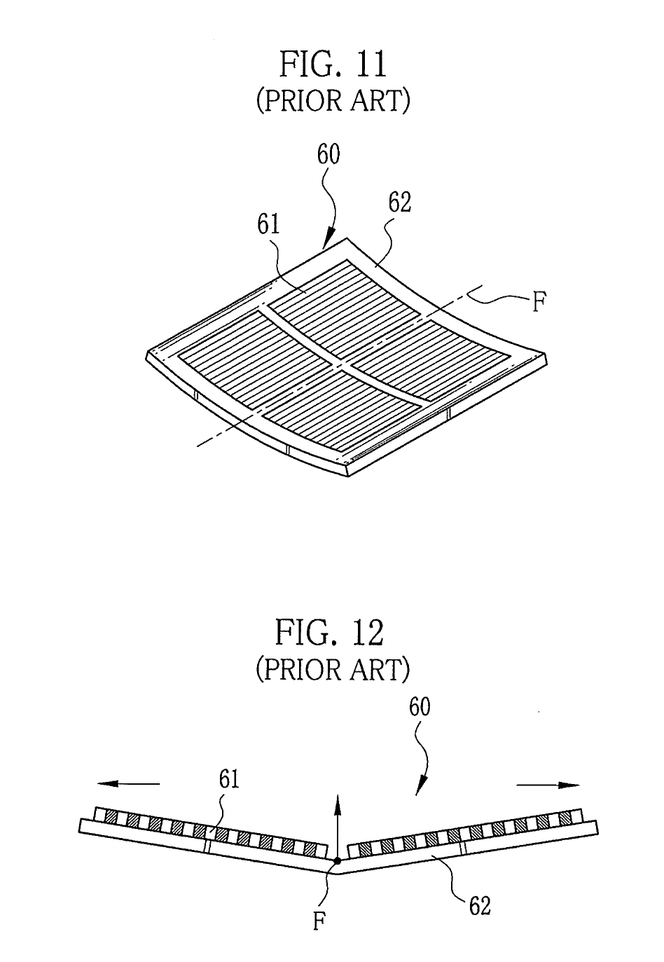

As shown in FIG. 10, a spherically curved diffraction grating 55 in a convex or concave shape may be used. In this case, stress concentration lines F extend radially from a center C of a substrate 56. It is preferable to arrange sub-diffraction gratings 57 on the substrate 56 such that each of the stress concentration lines F overlaps at least one of the sub-diffraction gratings 57 and the gaps between the sub-diffraction gratings 57 are out of alignment with each other in the direction of each of the stress concentration lines F.

In the above embodiments, the second diffraction grating 13 is described by way of example. The present invention is also applicable to the first diffraction grating 12 and the third diffraction grating 14. Arrangements of the sub-diffraction gratings are not limited to the above examples, and are included in the present invention so long as the stress concentration line F or each of the stress concentration lines F overlaps at least one of the sub-diffraction gratings. Additionally, it is more preferable that the gaps between the sub-diffraction gratings are out of alignment with each other in the direction of the stress concentration line F. Accordingly, the present invention includes embodiments where only a single sub-diffraction grating is joined to a substrate. The above embodiments can be performed in combination to the extent that the combination is consistent with the present invention. Furthermore, the diffraction grating in the X-ray imaging apparatus using the Talbot effect is described by way of example. The present invention is also applicable to a diffraction grating of an X-ray imaging system for phase contrast imaging not using the Talbot effect. Instead of the X-ray beams, it is possible to use gamma-ray beams or the like as the radiation.

Various changes and modifications are possible in the present invention and may be understood to be within the present invention.

What is claimed is:

1. A diffraction grating comprising:
a curved substrate having at least one stress concentration line where stress caused by a curve of the substrate concentrates; and
two or more sub-diffraction gratings, each of the sub-diffraction gratings having a grating structure, the grating structure being composed of radiation shielding members and radiation transmitting members arranged alternately, the sub-diffraction gratings being joined to the substrate such that the stress concentration line overlaps at least one of the sub-diffraction gratings.

2. The diffraction grating of claim 1, wherein the sub-diffraction gratings adjoin each other on the substrate such that gaps between the sub-diffraction gratings are out of alignment with each other in a direction of the stress concentration line.

3. The diffraction grating of claim 2, wherein the gaps are located on opposite sides of and equidistant from the stress concentration line.

4. The diffraction grating of claim 1, wherein the sub-diffraction gratings adjoin each other on the substrate and a gap between the sub-diffraction gratings intersects the stress concentration line.

5. The diffraction grating of claim 4, wherein a grating direction of the members and an edge of each sub-diffraction grating is nonparallel to each other.

6. The diffraction grating of claim 1, wherein the curve of the substrate is cylindrical.

7. The diffraction grating of claim 6, wherein the stress concentration line is located in a middle of the substrate in a curving direction of the substrate and extends orthogonally to the curving direction.

8. The diffraction grating of claim 1, wherein the curve of the substrate is spherical.

9. The diffraction grating of claim 8, wherein the substrate is circular in shape and the stress concentration lines radially extend from the center of the substrate.

10. The diffraction grating of claim 1, wherein the substrate has radiation transmission property and a thermal expansion coefficient according to that of the sub-diffraction grating.

11. A radiation imaging apparatus comprising:
a radiation source for emitting radiation;
a first diffraction grating for passing the radiation to form a fringe image;
a second diffraction grating for providing intensity modulation to the fringe image, the second diffraction grating being moved to relative positions that are out of phase with a periodic pattern of the fringe image;
a third diffraction grating disposed between the radiation source and the first diffraction grating, the third diffraction grating shielding the radiation, emitted from the radiation source, in an area-selective manner to form a plurality of line irradiation sources; and
a radiation image detector for detecting an intensity-modulated fringe image;
wherein at least one of the first to third diffraction gratings is a diffraction grating composed of a curved substrate and two or more sub-diffraction gratings, and each of the sub-diffraction gratings has a grating structure, and the grating structure is composed of radiation shielding members and radiation transmitting members arranged alternately, and the substrate has at least one stress concentration line where stress concentrates when the substrate is curved, and the sub-diffraction gratings are joined to the substrate such that the stress concentration line overlaps at least one of the sub-diffraction gratings.

12. A method for producing a diffraction grating comprising the steps of:
(A) joining two or more sub-diffraction gratings to a substrate, each of the sub-diffraction gratings having a grating structure, the grating structure being composed of radiation shielding members and radiation transmitting members arranged alternately, the substrate having at least one stress concentration line where stress concentrates when the substrate is curved, the sub-diffraction gratings being arranged on the substrate such that stress concentration line overlaps at least one of the sub-diffraction gratings; and
(B) curving the substrate before or after the step (A).
